(19) United States
(12) Patent Application Publication
(10) Pub. No.: US 2015/0309568 A1
(43) Pub. Date: Oct. 29, 2015

(54) ELECTRONIC APPARATUS AND EYE-GAZE INPUT METHOD

(71) Applicant: KYOCERA CORPORATION, Kyoto-shi, Kyoto (JP)

(72) Inventor: Yasuhiro MIKI, Ikoma-shi, Nara (JP)

(21) Appl. No.: 14/647,798

(22) PCT Filed: Nov. 27, 2013
(86) PCT No.: PCT/JP2013/081837

§ 371 Date: May 27, 2015

(30) Foreign Application Priority Data
Nov. 27, 2012 (JP) 2012-258413

(51) Int. Cl. G06F 3/01; G06F 3/041; G06F 3/00

(52) U.S. Cl. CPC G06F 3/013; G06F 3/005; G06F 3/041

(57) ABSTRACT

A mobile phone has a display etc. and detects an eye-gaze input based on a point of gaze of a user. The mobile phone performs predetermined processing relevant to an object if the eye-gaze input to the object displayed on the display is detected. If the point of gaze of the user is included to an area that displays a text of a digital book when a digital book application is performed, for example, a detection precision of the eye-gaze input is set in a low precision mode. On the other hand, when the point of gaze of the user is included to another area that does not display the text, the detection precision of the eye-gaze input is set in a high precision mode. Then, after the detection precision of the eye-gaze input is thus set, an eye-gaze of the user is detected.

### FIELD OF THE INVENTION

The present invention relates to an electronic apparatus and an eye-gaze input method, and more specifically, an electronic apparatus that detects an eye-gaze input, and an eye-gaze input method.

### BACKGROUND ART

A data input device that is an example of a background art displays an input data group of a menu, a keyboard, etc. on a display, photographs an eye portion of a user of the device with a camera, determines a direction of an eye-gaze of the user from a photography image, determines input data existing in the direction of the eye-gaze, and outputs determined input data to external equipment, etc.

An eye-gaze detection device that is another example of the background art detects an eye-gaze of a subject by detecting a center of a pupil and a corneal reflex point of the subject from a photography image.

### SUMMARY OF THE INVENTION

However, an eye-gaze input device has a tendency that the device becomes larger in proportion to a distance between a sensor and an eyeball. Therefore, if considering it is mounted on a small electronic apparatus such as a mobile terminal, for example, because the above-mentioned data input device or eye-gaze detection device is large, not appropriate.

Furthermore, when detecting an eye-gaze, it is necessary to keep on having tuned on power supplies of a camera, etc., and therefore, power consumption of a device becomes large. Although the power consumption does not become a problem so much if it is a non-portable type device, when it is a portable type device, large power consumption becomes a big problem.

Therefore, it is a primary object to provide a novel electronic apparatus and eye-gaze input method.

It is another object of the invention to provide an electronic apparatus and eye-gaze input method, capable of suppressing power consumption in detecting an eye-gaze of a user.

A first aspect of the present invention is an electronic apparatus that detects an eye-gaze input that is an input based on a point of gaze of a user, and performs an operation based on the eye-gaze input, comprising: a processor operable to perform detection processing for detecting the eye-gaze input; a display module operable to display a screen including a specific area and an object display area displaying an operating object; a detection module operable to detect the point of gaze; a first setting module operable to set a detection precision of the eye-gaze input in a first precision mode when the point of gaze of the user is included in the specific area; and a second setting module operable to set the detection precision of the eye-gaze input in a second precision mode that the detection precision is higher than the first precision mode when the point of gaze of the user is included in the object display area.

A second aspect of the present invention is an eye-gaze input method in an electronic apparatus that detects an eye-gaze input that is an input based on a point of gaze of a user, and performs an operation based on the eye-gaze input, and comprises a processor operable to perform detection processing for detecting the eye-gaze input and a display module operable to display a screen including a specific area and an object display area displaying an operating object, the processor of the electronic apparatus performs steps of: a first setting step to set a detection precision of the eye-gaze input in a first precision mode when the point of gaze of the user is included in the specific area; and a second setting step to set the detection precision of the eye-gaze input in a second precision mode that the detection precision is higher than the first precision mode when the point of gaze of the user is included in the object display area.

According to a form of the present invention, it is possible to suppress power consumption in detecting an eye-gaze of a user.

The above described objects and other objects, features, aspects and advantages of the invention will become more apparent from the following detailed description of the invention when taken in conjunction with the accompanying drawings.

### BRIEF DESCRIPTION OF THE DRAWINGS

FIG. 1 is an appearance view showing a mobile phone of an embodiment according to the present invention.

FIG. 2 is a block diagram showing electric structure of the mobile phone shown in FIG. 1.

FIG. 3 is an illustration view showing an example of a point of gaze that is detected on a display surface of a display shown in FIG. 1.

FIG. 4 is an illustration view showing an example of a pupil and a Purkinje image that are photographed by an infrared camera shown in FIG. 1.

FIG. 5 illustrates an example of an eye vector calculated by a processor shown in FIG. 2, wherein FIG. 5(A) shows an example of a first center position and a second center position, and FIG. 5(B) shows an example of the eye vector.

FIG. 6 is an illustration view showing a display example of objects displayed on the display shown in FIG. 1.

FIG. 7 is an illustration view showing an example of a memory map of the RAM shown in FIG. 2.

FIG. 8 is a flowchart showing an example of a part of eye-gaze input processing of a processor shown in FIG. 2.

FIG. 9 is a flowchart showing an example of another part of the eye-gaze input processing of the processor shown in FIG. 2, following FIG. 8.

FIG. 10 is an illustration view showing an example of an operation state when a high precision mode shown in FIG. 9 is set.

FIG. 11 is an illustration view showing an example of an operation state when a low precision mode shown in FIG. 9 of a specific example 1 is set.

FIG. 12 is an illustration view showing an example of an operation state when a low precision mode shown in FIG. 9 of a specific example 2 is set.

FIG. 13 is an illustration view showing an example of an operation state when a low precision mode shown in FIG. 9 of a specific example 3 is set.

FIG. 14 is a flowchart showing another example of the eye-gaze input processing of the processor shown in FIG. 2.

FIG. 15 illustrates display examples of objects displayed on the display shown in FIG. 1 in another embodiment.

### FORMS FOR EMBODYING THE INVENTION

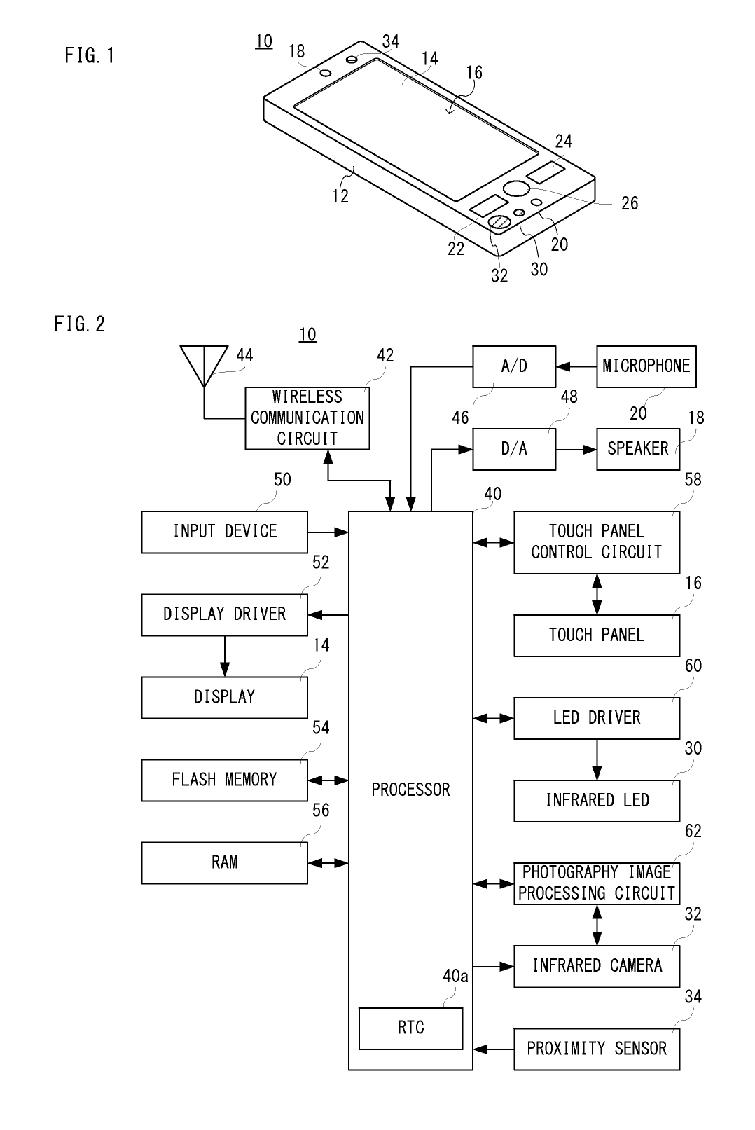

With referring to FIG. 1, a mobile phone 10 of an embodiment according to the present invention is a so-called smartphone, and includes a longitudinal flat rectangular housing 12. A display 14 that is constituted by a liquid crystal, organic EL or the like, and functions as a display module is provided on a main surface (front surface) of the housing 12. A touch panel 16 is provided on this display 14. A speaker 18 is housed in the housing 12 in one end portion of a longitudinal direction on a side of a front surface, and a microphone 20 is housed in another end portion of the longitudinal direction on the side of the front surface. As hardware keys, a call key 22, an end key 24 and a menu key 26 are provided together with the touch panel 16. Furthermore, an infrared LED 30 and an infrared camera 32 are provided in a left side of the microphone 20, and a proximity sensor 34 is provided in a right side of the speaker 18. In addition, a light emitting surface of the infrared LED 30, a photographing surface of the infrared camera 32 and a detecting surface of the proximity sensor 34 are provided to be exposed from the housing 12, and remaining portions thereof are housed in the housing 12.

For example, the user can input a telephone number by making a touch operation on the touch panel 16 with respect to a dial key displayed on the display 14, and start a telephone conversation by operating the call key 22. If the end key 24 is operated, the telephone conversation can be ended. In addition, by long-depressing the end key 24, it is possible to turn on/off a power of the mobile phone 10.

Furthermore, if the menu key 26 is operated, a menu screen is displayed on the display 14. The user can perform a selection operating to a software key or a menu icon by performing a touch operation with the touch panel 16 to the software key, the menu icon, etc. being displayed on the display 14 in that state.

In addition, although a mobile phone such as a smartphone will be described as an example of an electronic apparatus in this embodiment, it is pointed out in advance that the present invention can be applied to various kinds of electronic apparatuses each comprising a display. As an example of other electronic apparatuses, arbitrary electronic apparatuses such as a feature phone, a digital book terminal, a tablet terminal, a PDA, a notebook PC, a display device, etc. can be cited, for example.

With referring to FIG. 2, the mobile phone 10 of the embodiment shown in FIG. 1 includes a processor 40, and the processor 40 is connected with the infrared camera 32, the proximity sensor 34, a wireless communication circuit 42, an A/D converter 46, a D/A converter 48, an input device 50, a display driver 52, a flash memory 54, a RAM 56, a touch panel control circuit 58, an LED driver 60, a photography image processing circuit 62, etc.

The processor 40 is called a computer or a CPU, and in charge of whole control of the mobile phone 10. An RTC 40a is incorporated in the processor 40, and a date and time is counted by the RTC 40a. A whole or a part of a program set in advance in the flash memory 54 is, in use, developed or loaded into the RAM 56, and the processor 40 performs various kinds of processing in accordance with the program developed in the RAM 56. At this time, the RAM 56 is further used as a working area or buffer area for the processor 40.

The input device 50 includes the hardware keys (22, 24, 26) shown in FIG. 1, and functions as an operating module or an input module together with the touch panel 16 and the touch panel control circuit 58. Information (key data) of the hardware key that is operated by the user is input to the processor 40. Hereinafter, an operation with the hardware key is called “key operation”.

The wireless communication circuit 42 is a circuit for transmitting and receiving a radio wave for a telephone conversation, a mail, etc. via an antenna 44. In this embodiment, the wireless communication circuit 42 is a circuit for performing a wireless communication with a CDMA system. For example, if the user designates a telephone call (outgoing call) using the input device 50, the wireless communication circuit 42 performs telephone call processing under instructions from the processor 40 and outputs a telephone call signal via the antenna 44. The telephone call signal is transmitted to a telephone at the other end of line through a base station and a communication network. Then, if incoming call processing is performed in the telephone at the other end of line, a communication-capable state is established and the processor 40 performs the telephone conversation processing.

The microphone 20 shown in FIG. 1 is connected to the A/D converter 46, and a voice signal from the microphone 20 is input to the processor 40 as digital voice data through the A/D converter 46. The speaker 18 is connected to the D/A converter 48. The D/A converter 48 converts the digital voice data into a voice signal to apply to the speaker 18 via an amplifier. Therefore, a voice of the voice data is output from the speaker 18. Then, in a state where the telephone conversation processing is performed, a voice that is collected by the microphone 20 is transmitted to the telephone at the other end of line, and a voice that is collected by the telephone at the other end of line is output from the speaker 18.

In addition, the processor 40 adjusts, in response to an operation for adjusting a volume by the user, a voice volume of the voice output from the speaker 18 by controlling an amplification factor of the amplifier connected to the D/A converter 48.

The display driver 52 controls, under instructions by the processor 40, the display of the display 14 that is connected to the display driver 52. In addition, the display driver 52 includes a video memory that temporarily stores image data to be displayed. The display 14 is provided with a backlight that includes a light source of an LED or the like, for example, and the display driver 52 controls, according to the instructions from the processor 40, brightness, lighting/extinction of the backlight.

The touch panel 16 shown in FIG. 1 is connected to the touch panel control circuit 58. The touch panel control circuit 58 applies to the touch panel 16 a necessary voltage and so on and inputs to the processor 40 a touch start signal indicating a start of a touch by the user, a touch end signal indicating an end of the touch by the user, and coordinate data indicating a touch position. Therefore, the processor 40 can determine the user touches to which icon or key based on the coordinate data.

The touch panel 16 is a touch panel of an electrostatic capacitance system that detects a change of an electrostatic capacitance produced between a surface thereof and an object such as a finger that is in close to the surface. The touch panel 16 detects that one or more fingers are brought into contact to the touch panel 16, for example.

The touch panel control circuit 58 functions as a detection module, and detects a touch operation within a touch-effective range of the touch panel 16, and outputs coordinate data indicative of a position of the touch operation to the processor 40. The processor 40 can determine which icon or key is touched by the user based on the coordinate data that is input from the touch panel control circuit 58. The operation on the touch panel 16 is hereinafter called as “touch operation”.

In addition, a tap operation, a long-tap operation, a flick operation, a slide operation, etc. are included in the touch operation of this embodiment. In addition, for the touch panel 16, a surface-type electrostatic capacitance system may be adopted, or a resistance film system, an ultrasonic system, an infrared ray system, an electromagnetic induction system or the like may be adopted. Furthermore, a touch operation is not limited to a finger of the user, may be performed by a stylus pen etc.

Although not shown, the proximity sensor 34 includes a light emitting element (infrared LED, for example) and a light receiving element (photodiode, for example). The processor 40 calculates, from change of an output of the photodiode, a distance of an object (a user face etc., for example) that is in close to the proximity sensor 34 (mobile phone 10). Specifically, the light emitting element emits an infrared ray, and the light receiving element receives an infrared ray that is reflected by the face etc. When the light receiving element is far from a user face, for example, an infrared ray that is emitted from the light emitting element is hardly received by the light receiving element. On the other hand, when a user face approaches the proximity sensor 34, an infrared ray that is emitted by the light emitting element is reflected on the face to be received by the light receiving element. Since a light receiving amount by the light receiving element thus changes in a case where the proximity sensor 34 is in close to the user face or a case where that is not so, the processor 40 can calculate the distance from the proximity sensor 34 to an object based on the light receiving amount.

The infrared LED 30 shown in FIG. 1 is connected to an LED driver 60. The LED driver 60 switches on/off (lighting/extinction) of the infrared LED 30 based on a control signal from the processor 40.

An infrared camera 32 (see FIG. 1) that functions as a photography module is connected to the photography image processing circuit 62. The photography image processing circuit 62 performs image processing on photography image data from the infrared camera 32, and inputs monochrome image data into the processor 40. The infrared camera 32 performs photography processing under instructions of the processor 40, and inputs the photography image data into the photography image processing circuit 62. The infrared camera 30 is constituted by a color camera using an imaging device such as a CCD or CMOS and an infrared filter that reduces (cuts-off) lights of wavelengths of R, G and B and passes a light of wavelength of an infrared ray, for example. Therefore, if structure that the infrared filter can be freely attached or detached is adopted, by detaching the infrared filter, it is possible to obtain a color image.

In addition, the above-mentioned wireless communication circuit 42, A/D converter 44 and D/A converter 46 may be included in the processor 40.

In the mobile phone 10 having such structure, instead of a key operation or a touch operation, it is possible to perform an input operation by an eye-gaze (hereinafter, may be called “eye-gaze operation”). In the eye-gaze operation, predetermined processing that is set corresponding to a predetermined area (hereinafter, decision area) designated by a point (point of gaze) that an eye-gaze and the display surface of the display 14 intersect is performed. In the following, a detection method of a point of gaze will be described using drawings.

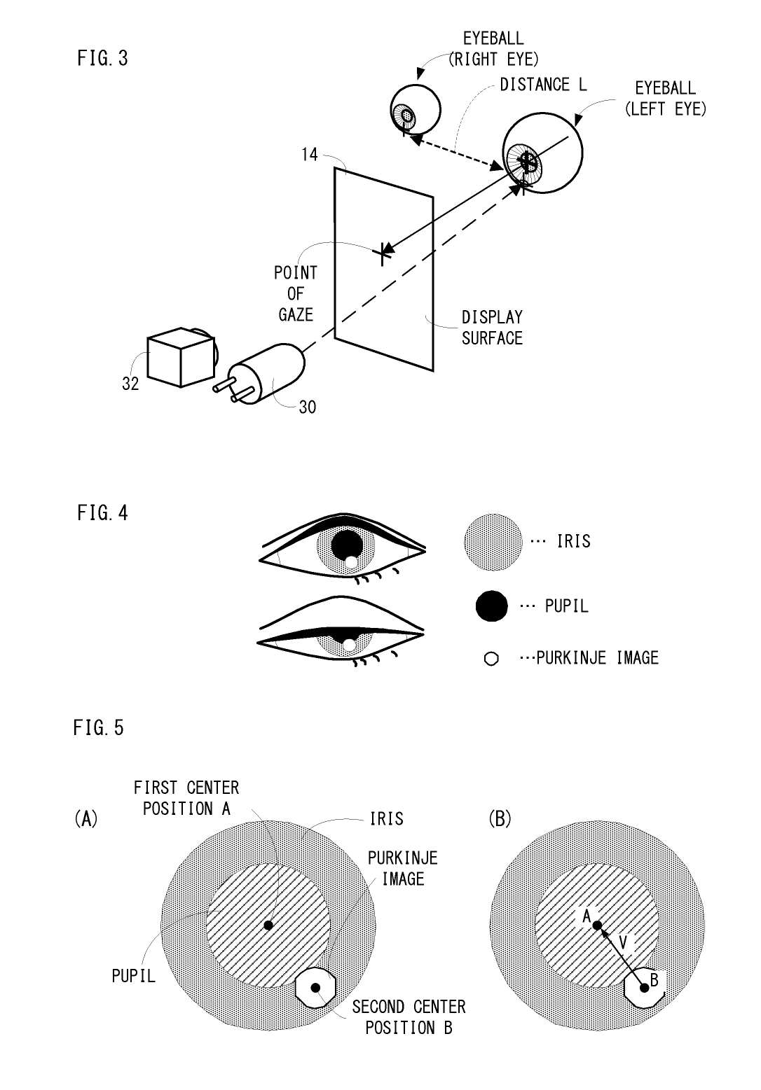

With reference to FIG. 3, a user sets own dominant eye among eyes on either side. If setting the dominant eye (here, left eye), a face of the user (photography subject) irradiated with the infrared ray emitted by the infrared LED 30 is photographed by the infrared camera 32. An eyeball circumference image is acquired using technology of characteristic point extraction to the photography image. Next, a pupil is detected by labeling processing to the eyeball circumference image that is acquired, and a reflection light (Purkinje image) by the infrared ray (infrared light) is detected by differential filtering processing. In addition, although methods of detecting the pupil and the Purkinje image from the photography image are outlined, since these methods are already well-known and not the essential contents of this embodiment, a detailed description thereof is omitted.

Since the infrared LED 30 and the infrared camera 32 are arranged below the display 14 side by side (closely arranged) as shown in FIG. 1, the Purkinje image can be detected even either a state that an eyelid is relatively largely opened or a state an eyelid is slightly closed, as shown in FIG. 4. In addition, the distance between the infrared LED 30 and the infrared camera 32 is determined by a distance between the user face and the mobile phone 10 (surface of the housing or display surface of the display 14) at the time that the user uses the mobile phone 10, a size of the mobile phone 10, etc.

If detecting a pupil and a Purkinje image from the photography image, the processor 40 detects a direction of the eye-gaze of the dominant eye (eye vector V). Specifically, a vector toward a position of the pupil from a position of the Purkinje image in a two-dimensional photography image that is photographed by the infrared camera 32 is detected. That is, as shown in FIGS. 5(A) and 5(B), a vector turned from the first center position A to the second center position B is the eye vector V. A coordinate system in the infrared camera 32 is determined in advance, and the eye vector V is calculated using the coordinate system.

Then, a calibration is performed as initial setting of an eye-gaze operation using the eye vector V thus calculated. In this embodiment, an eye vector V at the time that each of four (4) corners of the display 14 is gazed is acquired, and respective eye vectors V are saved as calibration data.

In performing an eye-gaze operation, a point of gaze is detected by evaluating an eye vector V at every time that an image is photographed by the infrared camera 32 and by comparing it with the calibration data. Then, when the number of times that the point of gaze is detected within the decision area corresponds to the number of decision times, the processor 40 detects that an eye-gaze input is made to that point of gaze.

Furthermore, in this embodiment, a distance L between both eyes of the user (see FIG. 3) is calculated based on center positions of Purkinje images of the both eyes. Then, the distance L of both eyes of the user is saved together with the calibration data. If the eye vector V is calculated by performing the processing that detects a point of gaze, the distance L of both eyes recorded at the time that the point of gaze is detected is compared with the distance L of both eyes at present to determine whether the distance between the display 14 and the user face changes. If determining that the distance between the display 14 and the face of the user changes, a change amount is calculated based on the distance L of both eyes being recorded and the distance L of both eyes at present, whereby a magnitude of the eye vector V is corrected. If it is determined based on the change amount that it is in a state where a position of the user face is departed in comparison with the position at the time of performing the calibration, the eye vector V is corrected so as to become large. If it is determined based on the change amount that it is in a state where a position of the user face is closed in comparison with the position at the time of performing the calibration, the eye vector V is corrected so as to become small.

Furthermore, although a detailed description is omitted, in point-of-gaze detection processing of this embodiment, an error that occurs with a shape of an eyeball, a measurement error at the time of the calibration, a quantization error at the time of photography, etc. are also corrected.

Therefore, in this embodiment, even if it is a small electronic apparatus such as the mobile phone 10, it becomes possible to implement a high-precision eye-gaze input.

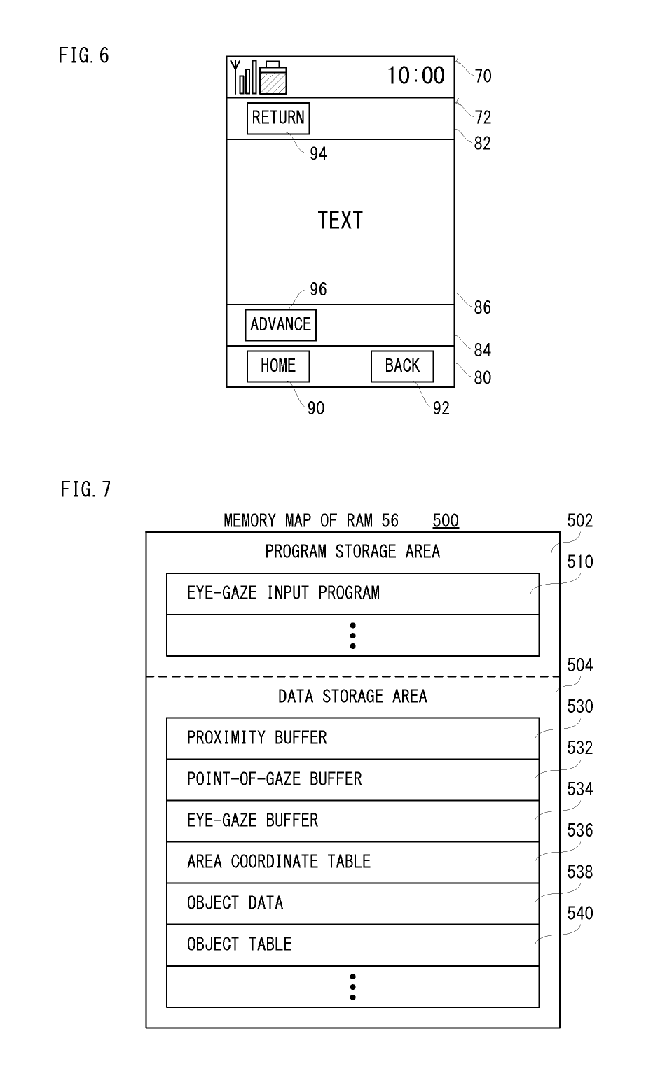

FIG. 6 is an illustration view showing a display example of the display 14 when a digital book application is being performed. The display 14 includes a status display area 70 and a function display area 72. In the status display area 70, an icon (picto) indicative of a radio-wave reception state by the antenna 44, an icon indicative of a residual battery capacity of a secondary battery and the time are displayed.

In the function display area 72, a standard key display area 80 displaying a HOME key 90 and a BACK key 92 that are standard keys, a first application key display area 82 displaying a return key 94 for returning to a previous page, a second application key display area 84 displaying an advance key 96 for advancing to a next page, a text display area 86 that a text of a digital book is displayed are included.

The HOME key 90 is a key for terminating the application being performed and displaying a standby screen. The BACK key 92 is a key for terminating the application being performed and displaying a screen before performing the application. Then, regardless of a kind of an application to be performed, the HOME key 90 and the BACK key 92 are displayed whenever the application is being performed.

Furthermore, when there is an unread new-arrival mail, missed call or the like, a notification icon is displayed in the status display area 70. For example, when a new-arrival mail is received, a new-arrival mail icon is displayed in the status display area 70 as the notification icon. Furthermore, when there is no unread new-arrival mail or missed call, the notification icon is not displayed.

In addition, a key, a GUI, a widget (gadget), etc. that are displayed on the display 14 are called an object collectively. Furthermore, the standard key display area 80, the first application key display area 82 and the second application key display area 84 may be called an object display area collectively.

Then, the user can arbitrarily operate the application being performed by performing an eye-gaze input to these objects. For example, if an eye-gaze input is performed to the return key 94 or the advance key 96, the page of the digital book currently displayed is changed.

Here, in this embodiment, when detection of an eye-gaze input is started, a detection precision of an eye-gaze input is changed based on a point of gaze of a user. In this embodiment, it is possible to set a low precision mode (a first precision mode) and a high precision mode (a second precision mode) that the detection precision of an eye-gaze input is higher than that of the low precision mode. Furthermore, in the low precision mode, since the processing for detecting an eye-gaze of the user is simplified, power consumption in detecting the eye-gaze of the user can be suppressed.

Then, when the detection of the eye-gaze input is started and the point of gaze of the user is included to the specific area, the detection precision of the eye-gaze input is set in the low precision mode. On the other hand, when the point of gaze of the user is not included to the specific area, the detection precision of the eye-gaze input is set in the high precision mode.

With reference to FIG. 6, for example, when the digital book application is performed, the text display area 86 is rendered as the specific area. This is because the detection of an eye-gaze input of the user is not so important in the area that the text of the digital book is displayed. Therefore, when the eye-gaze of the user is turned to the text of the digital book, the detection precision of the eye-gaze input is set in the low precision mode. On the other hand, when the eye-gaze of the user is turned to the object display area, there is a possibility that an eye-gaze input is performed to an object. Therefore, the detection precision of the eye-gaze input is set in the high precision mode.

It is possible to suppress the power consumption in detecting the eye-gaze of the user by thus changing the detection precision of the eye-gaze input based on the position of the point of gaze of the user.

In addition, since the high precision mode is set in a normal state and the low precision mode is set for detecting an eye-gaze input with low power consumption, the high precision mode may be called “normal mode”, and the low precision mode may be called “power-saving mode.”

Furthermore, in other embodiments, the high precision mode or low precision mode may be set, like above-mentioned digital book application, in performing the mail application or the browser application that a text is displayed. Furthermore, the specific area in case where another application is performed may be set for each application, or a case where the number of characters displayed in an area exceeds a predetermined value, it may be determined to be the specific area.

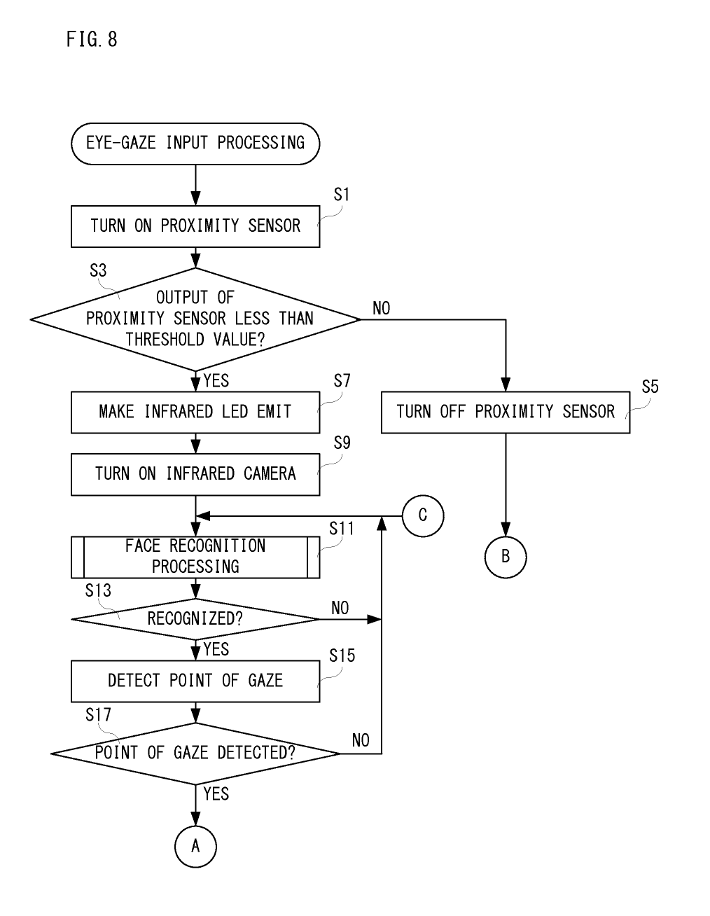

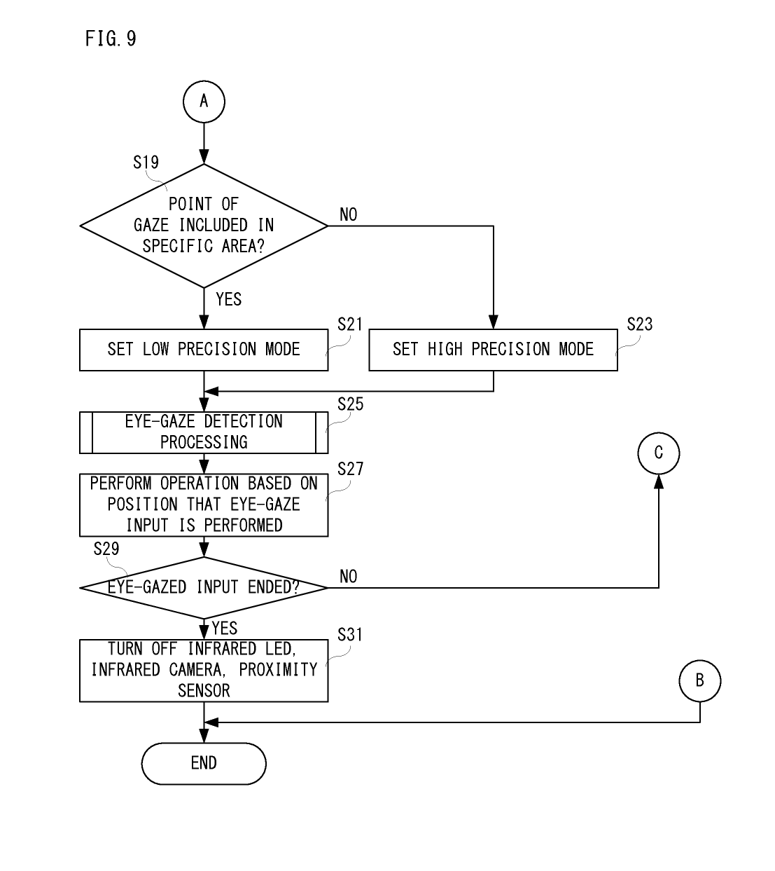

In the following, the outline of this embodiment will be described using a memory map 500 shown in FIG. 7 and flowcharts shown in FIG. 8-FIG. 9.

With reference to FIG. 7, a program storage area 502 and a data storage area 504 are formed in the RAM 56 shown in FIG. 2. As described previously, the program storage area 502 is an area for reading and storing (developing) a whole or a part of program data that is set in advance in the flash memory 54 (FIG. 2).

The program storage area 502 is stored with an eye-gaze input program 510 for performing an operation based on an eye-gaze input, etc. In addition, in the program storage area 502, programs for performing a telephone function, a mail function, an alarm function, etc. are also included.

The data storage area 504 is provided with a proximity buffer 530, a point-of-gaze buffer 532, an eye-gaze buffer 534, etc. Furthermore, the data storage area 504 is stored with an area coordinate table 536, object data 538, an object table 540, etc.

The proximity buffer 530 is temporarily stored with distance information to the object obtained from the proximity sensor 34. The point-of-gaze buffer 532 is temporarily stored with a point of gaze that is detected. When an eye-gaze input is detected, the eye-gaze buffer 534 is temporarily stored with its position.

The area coordinate table 536 is a table including information of coordinate ranges of the status display area 70, the function display area 72, the standard key display area 80, the first application key display area 82 and the second application key display area 84, for example. The object data 538 is data comprising image and character string data, etc. of an object to be displayed on the display 14. The object table 540 is a table including information of a display position (coordinate range) etc. of an object currently displayed on the display 14.

Although illustration is omitted, the data storage area 504 is further stored with other data necessary for performing respective programs stored in the program storage area 502, and provided with timers (counters) and flags.

The processor 40 processes a plurality of tasks including eye-gaze input processing shown in FIG. 8 and FIG. 9, etc., in parallel to each other under control by Linux (registered trademark)-basis OS such as Android (registered trademark), REX, etc. or other OS.

If an operation by an eye-gaze input is validated, eye-gaze input processing is performed. The processor 40 turns on the proximity sensor 34 in a step S1. That is, a distance from the mobile phone 10 to a user is measured by the proximity sensor 34. Subsequently, the processor 40 determines, in a step S3, whether an output of the proximity sensor 34 is less than a threshold value. That is, it is determined whether a user face exists within a range that an infrared ray emitted from the infrared LED 30 affects a user eye. If “NO” is determined in the step S3, that is, if the output of the proximity sensor 34 is equal to or more than the threshold value, the processor 40 turns off the proximity sensor 34 in a step S5, and terminates the eye-gaze input processing. That is, since the infrared ray that is output from the infrared LED 30 may affect the user eye, the eye-gaze input processing is terminated. In addition, in other embodiments, notification (pop-up or a voice, for example) that urges to depart the user face from the mobile phone 10 may be performed after the step S5.

If “YES” is determined in the step S3, that is, if the mobile phone 10 and the user face are in an appropriate distance, for example, the processor 40 turns on the infrared LED 30 in a step S7, and turns on the infrared camera 32 in a step S9. That is, in order to detect an eye-gaze input of the user, the infrared LED 30 and the infrared camera 32 are turned on.

Subsequently, the processor 40 performs face recognition processing in a step S11. That is, the processing that reads the image data of the user photographed by the infrared camera 32 from the RAM 56, and detects the user face from the image data of the user that is read is performed. Subsequently, the processor 40 determines whether the face is recognized in a step S13. That is, it is determined whether the user face is recognized by the face recognition processing. If “NO” is determined in the step S13, that is, if the user face is not recognized, the processor 40 returns to the processing of the step S11.

On the other hand, if “YES” is determined in the step S13, that is, if the user face is recognized, the processor 40 detects a point of gaze in a step S15. That is, a position on the display 14 that the user is gazing is detected. In addition, the coordinate of the point of gaze that is detected is recorded in the point-of-gaze buffer 532. Furthermore, the processor 40 that performs the processing of the step S15 functions as a detection module.

Subsequently, the processor 40 determines, in a step S17, whether a point of gaze can be detected. That is, the processor 40 determines whether the point of gaze of the user can be detected from the image of the face recognized. If “NO” is determined in the step S17, that is, if the point of gaze is not detected, the processor 40 returns to the processing of the step S11.

On the other hand, if “YES” is determined in the step S17, that is, if the point of gaze is detected, the processor 40 determines, in a step S19, whether the point of gaze is included in the specific area. It is determined whether the point of gaze currently recorded in the point-of-gaze buffer 532 is included in the coordinate range of the text display area 86 included in the area coordinate table 536, for example. If “YES” is determined in the step S19, that is, if the point of gaze of the user is included in the text display area 86 shown in FIG. 6, for example, the processor 40 sets the low precision mode in a step S21. On the other hand, if “NO” is determined in the step S19, that is, if the point of gaze is not included in the specific area, the processor 40 sets the high precision mode in a step S23. Then, if the processing of the step S21 or step S23 is ended, the processor 40 proceeds to processing of a step S25. In addition, the processor 40 that performs the processing of the step S21 functions as a first setting module, and the processor 40 that performs the processing of the step S23 functions as a second setting module.

Subsequently, the processor 40 performs eye-gaze detection processing in the step S25. That is, an eye-gaze input by the user is detected based on the detection precision being set.

Subsequently, the processor 40 performs an operation based on the position that the eye-gaze input is performed in a step S27. When the eye-gaze input is performed to an object, for example, an application or processing relevant to the object is performed. However, if neither processing nor operation is related to a character when the eye-gaze input is detected to the character of the text display area 86, the processor 40 does not perform an operation in particular.

Subsequently, the processor 40 determines, in a step S29, whether the eye-gaze input is ended. The processor 40 determines whether an operation that the eye-gaze input is invalidated is performed, for example. If “NO” is determined in the step S29, that is, if the eye-gaze input is not ended, the processor 40 returns to the processing of the step S11. On the other hand, if “YES” is determined in the step S29, that is, if the eye-gaze input is ended, the processor 40 turns off the infrared LED 30, the infrared camera 32 and the proximity sensor 34 in a step S31. That is, the power consumption of the mobile phone 10 is suppressed by turning off the power supplies of them. Then, if the processing of the step S31 is ended, the processor 40 terminates the eye-gaze input processing.

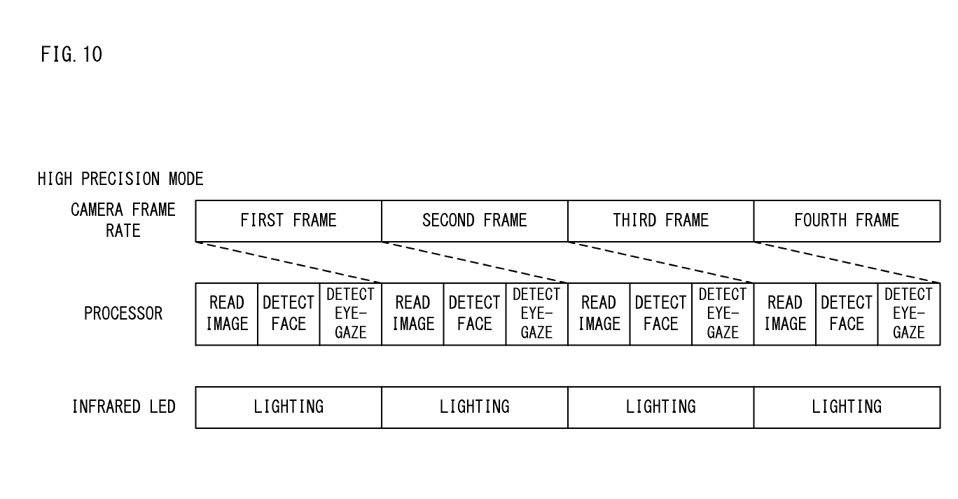

Although the outline of this embodiment is described above, in the following, specific examples in the low precision mode will be described using illustration views showing in FIG. 10-FIG. 13.

### Specific Example 1

In a first low precision mode of the specific example 1, a frame rate of the infrared camera 32 is made lower than that of the high precision mode. In the following, operation states in the high precision mode and the first low precision mode will be described in comparison to each other.

FIG. 10 is an illustration view showing the operation states of the infrared camera 32, the processor 40 and the infrared LED 30 when setting the high precision mode. In the high precision mode, the infrared LED 30 is always lightened, and the infrared camera 32 outputs a photography image at a frame rate of 20 fps (Frames per Second). Furthermore, if a photography image is input to the processor 40 after the photography image is output to the photography image processing circuit 62 from the infrared camera 32 and subjected to predetermined processing in the photography image processing circuit 62, the processor 40 saves the photography image in the buffer of the RAM 56 once, and performs processing required for eye-gaze detection to the photography image. As the processing required for eye-gaze detection, the processor 40 performs image reading processing that reads the photography image input from the photography image processing circuit 62 from the buffer of the RAM 56, face recognition processing that recognizes a face from the photography image that is read, eye-gaze detection processing that detects the eye-gaze of the user, etc., for example. Then, the processor 40 performs these processing to each photography image that is output from the infrared camera 32 during a time that the eye-gaze detection is validated. In addition, since the processor 40 performs the processing required for eye-gaze detection after receiving the photography image from the image processing circuit 62, there occurs a time lag between a timing that the photography image is output from the infrared camera 32 and a timing that the processor 40 performs the processing required for eye-gaze detection.

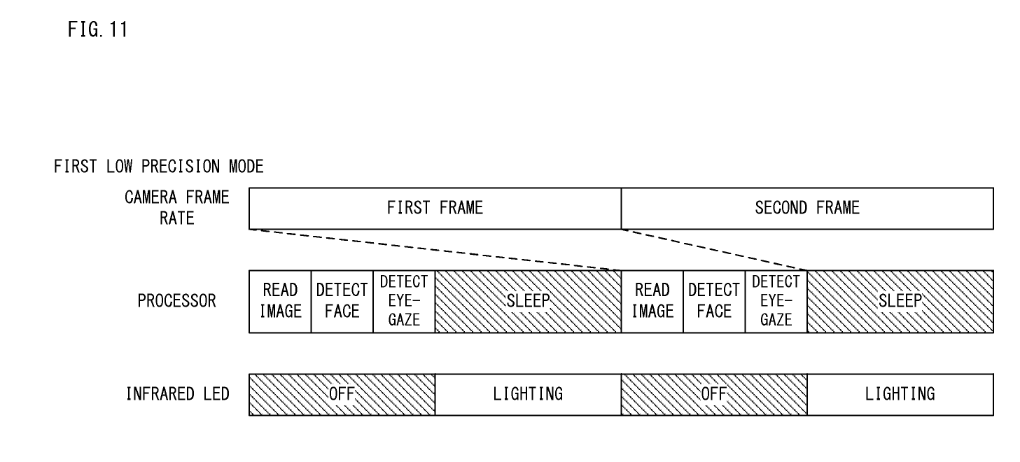

FIG. 11 is an illustration view showing the operation states of the infrared camera 32, the processor 40 and the infrared LED 30 when setting the first low precision mode. In the first low precision mode, the infrared camera 32 outputs the photography image at the frame rate of the half to the frame rate in the high precision mode, i.e., the frame rate of 10 fps. Therefore, after the infrared LED 32 is turned on just before the photography, and turned off until the next frame is output. That is, the infrared LED 32 blinks corresponding to the output of the photography image. Then, if the processing required for eye-gaze detection is performed to the photography image that is input, the processor 40 shifts to a sleep state until the next photography image is input. Therefore, in the first low precision mode, a time until the eye-gaze input is detected, i.e., responsibility at a time that the user performs the eye-gaze input becomes lower than the high precision mode, and accordingly, the user feels that the detection precision in the first low precision mode becomes lower than that of the high precision mode.

It is possible to suppress the power consumption of the infrared camera 32 during a time that the eye-gaze is detected by thus lowering the frame rate of the infrared camera 32. As a result, the power consumption in detecting the eye-gaze of the user can be suppressed. Furthermore, by lowering the frame rate of the infrared camera 32, it is also possible to suppress the power consumption of the infrared LED 30 and the processor 40.

### Specific Example 2

In the second low precision mode of the specific example 2, a frequency that the processor 40 detects an eye-gaze is made lower than the high precision mode. In the following, the operation states in the high precision mode and the second low precision mode will be described in comparison to each other. However, the high precision mode has been described, a detailed description is omitted here.

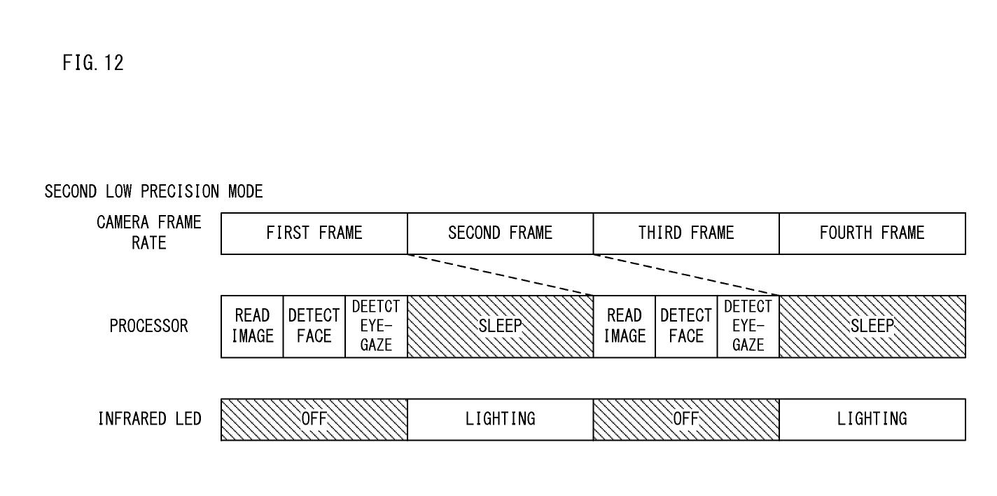

FIG. 12 is an illustration view showing the operation states of the infrared camera 32, the processor 40 and the infrared LED 30 when setting the second low precision mode. A frequency of the processor 40 in the second low precision mode is made lower than that in the high precision mode. For example, the processor 40 shifts to a sleep state after the processing required for eye-gaze detection is performed, and even if the next frame is output, the processor 40 does not perform the processing required for eye-gaze detection. Then, when the next frame is further output, the processor returns from the sleep state, and performs the processing required for eye-gaze detection. At this time, the frame rate of the infrared camera 32 is not changed, and the infrared LED 30 blinks at the same frequency as the specific example 1. Therefore, also in the second low precision mode, like the first low precision mode, since a time until the eye-gaze input is detected, i.e., the responsibility at a time that the eye-gaze input is performed becomes lower than the high precision mode, the user feels that the detection precision in the second low precision mode becomes lower than that of the high precision mode.

Thus, in the specific example 2, since the power consumption of the processor 40 in detecting the eye-gaze can be suppressed without changing the frame rate of the infrared camera 32, it is possible to suppress the power consumption at a time that the eye-gaze of the user is detected.

In addition, in other embodiments, the processor 40 may skip the processing required for eye-gaze detection without shifting to the sleep state.

### Specific Example 3

In the third low precision mode of the specific example 3, first eye-gaze detection processing that is the same as the eye-gaze detection processing performed in the high precision mode and second eye-gaze detection processing having an algorithm that is simplified than the first eye-gaze detection processing are performed. In the following, operation states in the high precision mode and the third low precision mode will be described in comparison to each other. However, the high precision mode has been described, a detailed description is omitted here.

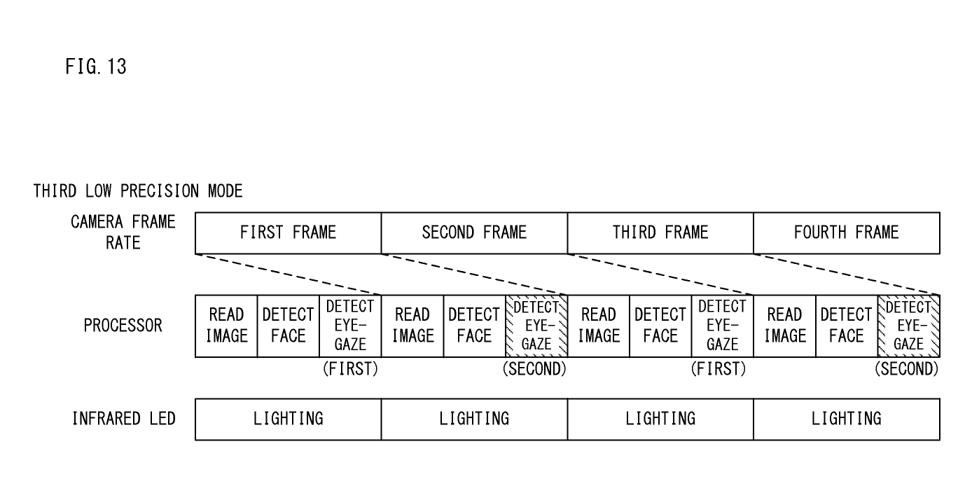

FIG. 13 is an illustration view showing the operation states of the infrared camera 32, the processor 40 and the infrared LED 30 when setting the third low precision mode. In the third low precision mode, the first eye-gaze detection processing and the second eye-gaze detection processing are performed alternately. For example, if the first eye-gaze detection processing is performed to the photography image of the first frame, the second eye-gaze detection processing is performed to the next photography image of the second frame. Then, to a further next photography image of the third frame, the first eye-gaze detection processing is performed again. Furthermore, the operations of the infrared LED 30 and the infrared camera 32 are approximately the same as those of the high precision mode. It should be noted that the power consumption of the processor 40 that performs the second eye-gaze detection processing becomes lower than the time of performing the first eye-gaze detection processing.

For example, although the position of the eye-gaze input is detected in the precision of “one (1) pixel” in the first eye-gaze detection processing, the position of the eye-gaze input is detected by the second eye-gaze detection processing in the precision of “one (1) area” comprising a plurality of pixels. That is, in the second eye-gaze detection processing, the precision of the position of the point of gaze detected becomes low in comparison to the first eye-gaze detection processing. Therefore, the user feels that the detection precision in the third low precision mode becomes lower than that of the high precision mode.

Thus, by simplifying the algorithm of the eye-gaze detection processing, it is possible to suppress the power consumption in detecting the eye-gaze of the user without changing the operations of the hardware (the infrared LED 30, the infrared camera 32, etc.).

In addition, the specific example 1 to the specific example 3 may be combined with each other arbitrarily. For example, like the third embodiment, the first eye-gaze detection processing and the second eye-gaze detection processing may be performed by turns in the specific example 1 and the specific example 2. Furthermore, whenever the low precision mode is set, the second eye-gaze detection processing may be always performed in all the specific examples. In addition, since it can imagine easily about other combinations, a detailed description is omitted here.

In other embodiments, in order to increase the detection decision of the distance from the mobile phone 10 to the user, the proximity sensor 34 may be provided to be adjacent to the infrared LED 30 and the infrared camera 32. Furthermore, in other embodiments, the infrared LED 30 and the infrared camera 32 may be provided to be adjacent to the proximity sensor 34.

In other embodiments, the proximity of the user face to the mobile phone 10 may be detected using the infrared LED 30 and the infrared camera 32 instead of the proximity sensor 34. Specifically, if the eye-gaze input processing is started, the infrared LED 30 is made to weak-emit, and a light reception level of the infrared camera 32 is measured. When the light reception level is equal to or more than a threshold value, it is determined that the user face exists within a range that the infrared ray that is output from the infrared LED 30 affects the user eye, and the processor 40 terminates the eye-gaze input detection processing. On the other hand, if the light reception level is less than the threshold value, the infrared LED 30 is made to normal-emit, and as mentioned above, an eye-gaze input of the user is detected. In addition, the light reception level of the infrared camera 32 is calculated based on a shutter speed and an amplifier gain value. For example, when an illuminance is high, the shutter speed becomes quick and the amplifier gain value becomes low. On the other hand, when the illuminance is low, the shutter speed becomes slow and the amplifier gain value becomes high.

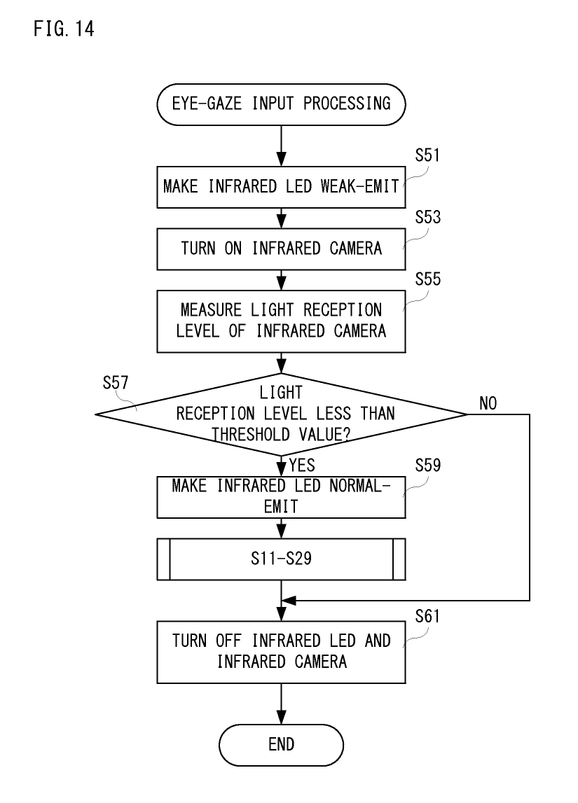

In the following, the eye-gaze input processing of the other embodiment will be described in detail using a flowchart thereof. With reference to FIG. 14, if the eye-gaze input processing of the other embodiment is performed, the processor 40 makes the infrared LED 30 weak-emit in a step S51, and turns on the power supply of the infrared camera 32 in a step S53. Subsequently, the processor 40 measures the light reception level of the infrared camera 32 in a step S55. That is, the light reception level of the infrared camera 32 is calculated based on the shutter speed and the amplifier gain value of the infrared camera 32.

Subsequently, the processor 40 determines, in a step S57, whether the light reception level is less than a threshold value. That is, like the step S3, it is determined whether the user face exists in the range that the infrared ray output from the infrared LED 30 affects the user eye. If “NO” is determined in the step S57, that is, if the light reception level is equal to or more than the threshold value, the processor 40 proceeds to processing of a step S61. Then, the processor 40 turns off the infrared LED 30 and the infrared camera 32 in the step S61, and terminates the eye-gaze input processing.

On the other hand, if “YES” is determined in the step S57, that is, if the light reception level is less than the threshold value, the processor 40 renders the infrared LED 30 into a state of normal-emit in a step S59. Subsequently, after the processing of the steps S11-S29 is performed and thus an eye-gaze input of the user is detected, the processor 40 proceeds to processing of a step S61. In the step S61, as mentioned above, the infrared LED 30 and the infrared camera 32 are turned off. That is, since the eye-gaze input is detected, the power supply of the infrared LED 30 and the infrared camera 32 is turned off. Then, if the processing of the step S61 is ended, the processor 40 terminates the eye-gaze input processing.

Although a case where the processing of the processor is performed by an eye-gaze operation is described in this embodiment, it is needless to say that the key operation, the touch operation and the eye-gaze operation may be combined. However, in other embodiments, the key operation and the touch operation may not be received when the processing by the eye-gaze operation is performed.

Although a case where the eye-gaze operation is possible in this embodiment, in fact, there are a case where the eye-gaze operation (eye-gaze input) is possible and a case not possible. The case where the eye-gaze operation is possible is the time that an application that is set in advance that the eye-gaze operation is possible is performed, for example. As an example of such an application is the digital book application, the mail application, etc. can be cited. On the other hand, the case where the eye-gaze operation is not possible is the time that an application that is set in advance that the eye-gaze operation is impossible is performed, for example. As an example of such application, the telephone function can be cited. Furthermore, if the eye-gaze operation is possible, a message or image (icon) to that effect may be displayed. When the eye-gaze operation is being performed, a message or image that the eye-gaze input can be received or that the eye-gaze operation is being performed may be displayed. If performing such display, the user can recognize that the eye-gaze operation is possible and that the eye-gaze input is being received.

Furthermore, if the mobile phone 10 has an acceleration sensor or a gyroscope sensor, validity/invalidity of the eye-gaze operation may be switched according to an orientation of the mobile phone 10.

Furthermore, the infrared camera 32 of other embodiments may have high sensitivity to the infrared ray in comparison to a normal color camera. Furthermore, in other embodiments, an infrared cut filter (low pass filter) that reduces (cuts) a light of the infrared wavelength but a light of the wavelength of R, G and B is made to be received better may be provided on a color camera that constitutes the infrared camera 32. In a case of the infrared camera 32 that is provided with the infrared cut filter, a sensitivity of the light of the infrared wavelength may be enhanced. Furthermore, it may be constructed such that the infrared cut filter is attachable to or detachable from the infrared camera 32.

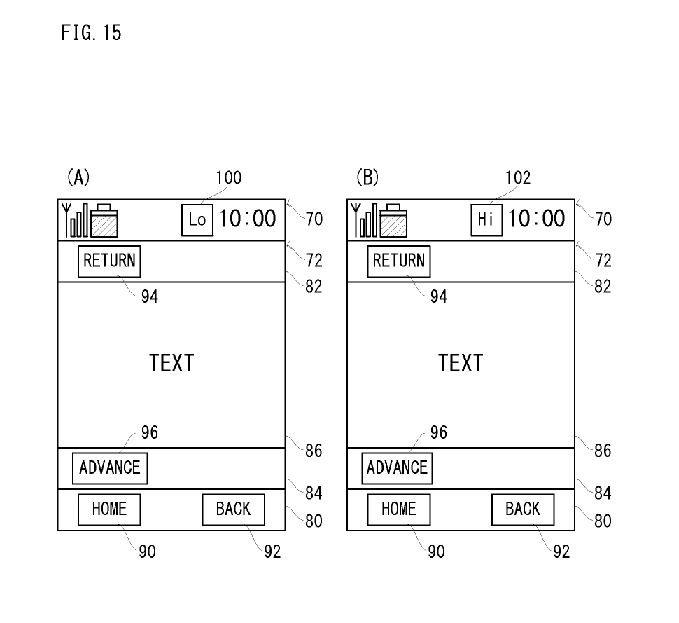

In other embodiments, a mode icon that indicates a mode currently set may be shown to the user. With reference to FIGS. 15(A) and 15(B), for example, when the low precision mode (power saving mode) is set, a first mode icon 100 comprising a character string of “Lo” is displayed on the status display area 70. On the other hand, when the high precision mode is set, a second mode icon 102 comprising a character string of “Hi” is displayed on the status display area 70. Thus, by displaying the first mode icon 100 or the second mode icon 102, the user can grasp the current mode adequately by the first mode icon 100 or the second mode icon 102.

However, only when one of the modes is set, the first mode icon 100 or the second mode icon 102 may be displayed. For example, when the low precision mode is set, the first mode icon 100 is made not to be displayed, and only when the high precision mode is set, the second mode icon 102 may be displayed.

Programs used in the above-described embodiments may be stored in an HDD of the server for data distribution, and distributed to the mobile phone 10 via the network. The plurality of programs may be stored in a storage medium such as an optical disk of CD, DVD, BD or the like, a USB memory, a memory card, etc. and then, such the storage medium may be sold or distributed. In a case that the programs downloaded via the above-described server or storage medium are installed to an electronic apparatus having the structure equal to the structure of the embodiment, it is possible to obtain advantages equal to advantages according to the embodiment.

The specific numerical values mentioned in this specification are only examples, and changeable properly in accordance with the change of product specifications.

It should be noted that reference numerals inside the parentheses and the supplements show one example of a corresponding relationship with the embodiments described above for easy understanding of the invention, and do not limit the invention.

An embodiment is an electronic apparatus that detects an eye-gaze input that is an input based on a point of gaze of a user, and performs an operation based on the eye-gaze input, comprising: a processor operable to perform detection processing for detecting the eye-gaze input; a display module operable to display a screen including a specific area and an object display area displaying an operating object; a detection module operable to detect the point of gaze; a first setting module operable to set a detection precision of the eye-gaze input in a first precision mode when the point of gaze of the user is included in the specific area; and a second setting module operable to set the detection precision of the eye-gaze input in a second precision mode that the detection precision is higher than the first precision mode when the point of gaze of the user is included in the object display area.

In this embodiment, the electronic apparatus (10: reference numeral exemplifying a portion or module corresponding in the embodiment, and so forth) performs the detection processing to detect an input by an eye-gaze (hereinafter, called an eye-gaze input). When the number of times that the point of gaze is detected in the same position reaches the number of decision times in a state where the detection processing is performed, for example, an eye-gaze input is detected. Furthermore, if the eye-gaze input is detected, an operation is performed based on the input position. The display module (14) displays the screen including the specific area that the text by a digital book application is displayed, for example and the object display area that displays the object for operating the digital book application, for example. The detection module (40, S15) detects the point of gaze of the user. The first setting module (40, S21) sets the detection precision of the eye-gaze input in the first precision mode (low precision mode) when the point of gaze of the user is included in the specific area that the text by the digital book application is displayed, for example. On the other hand, the second setting module (40, S23) sets the detection precision of the eye-gaze input in the second precision mode (high precision mode) that the detection precision is higher than the first precision mode when the point of gaze of the user is included in the object display module that operates the digital book application, for example.

According to the embodiment, it is possible to suppress the power consumption in detecting the eye-gaze of the user by changing the detection precision of the eye-gaze input based on the position of the eye-gaze of the user.

A further embodiment further comprises a camera for detecting the eye-gaze input, wherein a frame rate of the camera is made low when the first precision mode is set.

In the further embodiment, the camera (32) is provided in the electronic apparatus in order to detect the eye-gaze input. Then, when the first precision mode is set, the frame rate of the camera is set low.

According to the further embodiment, the power consumption of the camera in detecting the eye-gaze can be suppressed by lowering the frame rate of the camera. As a result, it is possible to suppress the power consumption in detecting the eye-gaze of the user.

In a still further embodiment, a processing frequency of the processor is set low when the first precision mode is set.

In the still further embodiment, if the first precision mode is set, the processor lowers the frequency that the processing for detecting the eye-gaze input is performed.

According to the still further embodiment, since the power consumption of the processor in detecting the eye-gaze can be suppressed, it is possible to suppress the power consumption in detecting the eye-gaze of the user.

In a yet further embodiment, when the first precision mode is set, an algorithm of the detection processing by the processor is simplified.

In the yet further embodiment, if the algorithm of the eye-gaze input processing is simplified, the precision of the input position of the eye-gaze detected becomes low in comparison to a state where the second precision mode is set, for example.

According to the yet further embodiment, it is possible to suppress the power consumption in detecting the eye-gaze of the user by simplifying the algorithm of the eye-gaze detection processing without changing operations of the hardware.

The other embodiment is an eye-gaze input method in an electronic apparatus that detects an eye-gaze input that is an input based on a point of gaze of a user, and performs an operation based on the eye-gaze input, and comprises a processor operable to perform detection processing for detecting the eye-gaze input and a display module operable to display a screen including a specific area and an object display area displaying an operating object, the processor of the electronic apparatus performs steps of: a first setting step to set a detection precision of the eye-gaze input in a first precision mode when the point of gaze of the user is included in the specific area; and a second setting step to set the detection precision of the eye-gaze input in a second precision mode that the detection precision is higher than the first precision mode when the point of gaze of the user is included in the object display area.

In the other embodiment, it is also possible to suppress the power consumption in detecting the eye-gaze of the user by changing the detection precision of the eye-gaze input based on the position of the eye-gaze of the user.

Although the present invention has been described and illustrated in detail, it is clearly understood that the same is by way of illustration and example only and is not to be taken by way of limitation, the spirit and scope of the present invention being limited only by the terms of the appended claims.

### DESCRIPTION OF NUMERALS

10—mobile phone
14—display
16—touch panel
30—infrared LED
32—infrared camera
34—proximity sensor
40—processor
50—input device
54—flash memory
56—RAM
60—LED driver
62—imaged image processing circuit

1. An electronic apparatus that detects an eye-gaze input that is an input based on a point of gaze of a user, comprising:
a display module operable to display a screen including a specific area and an object display area in which an operating object is displayed;
a processor operable to perform detection processing for detecting the eye-gaze input, the detection processing comprising;
detecting the point of gaze of the user,
setting a detection precision of the eye-gaze input in a first precision mode when the point of gaze of the user is included in the specific area, and
setting the detection precision of the eye-gaze input in a second precision mode that the detection precision is higher than the first precision mode when the point of gaze of the user is included in the object display area.

2. The electronic apparatus according to claim 1, further comprising a camera for detecting the eye-gaze input, wherein
a frame rate of the camera in the first precision mode is set lower than a frame rate in the second precision mode.

3. The electronic apparatus according to claim 1, wherein a processing frequency of the processor in the first precision mode is set lower than a processing frequency in the second precision mode.

4. The electronic apparatus according to claim 1, wherein when the first precision mode is set, an algorithm of the detection processing by the processor is simplified in comparison with an algorithm in the second precision mode.

5. An eye-gaze input method in an electronic apparatus that detects an eye-gaze input that is an input based on a point of gaze of a user, and comprises a display module operable to display a screen including a specific area and an object display area in which an operating object is displayed, and a processor operable to perform detection processing for detecting the eye-gaze input, the detection processing comprising steps of:
setting a detection precision of the eye-gaze input in a first precision mode when the point of gaze of the user is included in the specific area; and
setting the detection precision of the eye-gaze input in a second precision mode that the detection precision is higher than the first precision mode when the point of gaze of the user is included in the object display area.
